(19) United States
(12) Patent Application Publication
(10) Pub. No.: US 2011/0276505 A1
(43) Pub. Date: Nov. 10, 2011

(54) SYSTEMS AND METHODS FOR PROVIDING CREDIBILITY METRICS FOR JOB REFERRALS

(76) Inventor: Steven J. Schmitt, Pittsburgh, PA (US)

(21) Appl. No.: 13/100,706

(22) Filed: May 4, 2011

Related U.S. Application Data
(60) Provisional application No. 61/331,371, filed on May 4, 2010.

(51) Int. Cl. G06Q 10/00

(52) U.S. Cl. 705/321

(57) ABSTRACT

Methods and systems for assigning a credibility score for referrals provided through a professional talent management platform are described herein. Embodiments provide for registering members with the platform, listing available positions, accepting position referrals from the members, and associate credibility scores with the platform members.

### CROSS REFERENCE TO RELATED APPLICATION

This application claims the benefit of U.S. Provisional Patent Application Ser. No. 61/331,371, entitled “Systems and Methods for Multi-Level Professional Referral Social Networking,” filed on May 4, 2010, the contents of which are incorporated by reference as if fully set forth herein.

### FIELD OF THE INVENTION

The subject matter presented herein generally relates to Internet-based talent management in relation to professional recruitment and candidate referrals, including providing credibility metrics related to candidate referrals, and systems and methods therefor.

### BACKGROUND

Employers currently have a limited number of resources for locating candidates for open positions. Typical methods include print advertising and partnering with staffing and recruitment agencies. More recently, a first wave of web sites established the feasibility of utilizing the Internet to post employment positions and search for potential candidates, for example, through online job boards. Among these web sites are resume posting and job search sites, such as MONSTER.COM®. MONSTER.COM is a registered trademark of TMP Worldwide Inc. in the United States and other countries. Although the Internet is now considered a vital job placement resource, online job boards and recruitment sites have long been losing their effectiveness, especially in high demand industries such as information technology and healthcare, and have not adapted to fully realize the potential of recent technological advances.

### BRIEF SUMMARY

In summary, one aspect of the invention provides a system comprising: one or more processors; a system memory operatively coupled to the one or more processors; and one or more professional talent management modules communicatively coupled to the system memory, wherein the one or more professional talent management modules are adapted to: register one or more members; list one or more positions; accept one or more referrals for the one or more position from the one or more members; and associate one or more credibility scores with the one or more members.

In summary, another aspect of the invention provides a method comprising registering one or more members; listing one or more positions; accepting one or more referrals for the one or more position from the one or more members; and associating one or more credibility scores with the one or more members.

In summary, one aspect of the invention provides a computer program product comprising: a computer readable storage medium having computer readable program code embodied therewith, the computer readable program code comprising: computer readable program code configured to register one or more members; computer readable program code configured to list one or more positions; computer readable program code configured to accept one or more referrals for the one or more position from the one or more members; and computer readable program code configured to associate one or more credibility scores with the one or more members.

### BRIEF DESCRIPTION OF THE SEVERAL VIEWS OF THE DRAWINGS

FIG. 1 provides example talent management platform interface according to an embodiment.

FIG. 2 provides an example member network for Member 1 according to an embodiment.

FIG. 3 provides an example multi-level member network according to an embodiment.

FIG. 4 provides an example member network according to one embodiment.

FIG. 5 provides an example of calculating a credibility score according to an embodiment.

FIG. 6 provides an example of an employer member interface according to an embodiment.

FIG. 7 provides an example computer system.

### DETAILED DESCRIPTION

It will be readily understood that components of the embodiments, as generally described and illustrated in the figures herein, may be arranged and designed in a wide variety of different configurations in addition to the described example embodiments. Thus, the following more detailed description of embodiments, as represented in the figures, is not intended to limit the scope of the invention, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that various embodiments can be practiced without one or more of the specific details, or with other methods, components, materials, et cetera. In other instances, well-known structures, materials, or operations are not shown or described in detail to avoid obfuscation. Throughout this description, example embodiments may be described in connection with a computer, such as a desktop, laptop, or notebook computer; however, those skilled in the art will recognize that certain embodiments are equally applicable to other types of electronic devices.

A successful organization today must recruit and retain the best talent to remain competitive. However, there is little alternative but to rely on inefficient conventional methods, such as print advertising and online job boards, or to partner with firms in the professional staffing industry that depend on inefficient tools, technologies, and processes. These firms include staffing, recruiting, headhunting, and consulting firms. Although these professional staffing firms are able to provide some assistance to employers, research suggests they have ultimately created an environment that lacks certain necessary characteristics, such as efficiency, trust, reliability, and accountability.

While endeavoring to recruit and retain talent, human resource (HR) departments are also being faced with several other critical issues, including a massive shortage of skilled professionals, a hyper-competitive business climate, a complicated global workforce, and the increased specialization of labor. These issues are exacerbated in industries where demand for qualified professionals significantly exceeds supply, such as information technology, healthcare, and energy. Accordingly, employers and HR managers, who are often under enormous pressure to attract talent, are seeking innovative, trustworthy, and effective ways to connect with qualified candidates and to maintain current operations in sync with their organization's efforts to fuel new growth.

Personal referrals have long been an effective source for obtaining quality candidates for job openings. Referrals are important because they create a connection between the employer and the candidate that an application from an unknown or non-recommended individual simply cannot provide. However, most employers cannot rely on referrals alone because of their personal and incidental nature.

Certain organizations have attempted to create platforms that allow individuals to refer candidates for open positions. For example, an organization may have an internal referral program wherein an employee receives some form of compensation for referring a qualified candidate for an open position or, more commonly, if the referred candidate is hired for the open position. Similarly, certain professional staffing firms may have referral systems wherein individuals outside an organization are compensated for recommending a qualified candidate who ultimately is hired for an open position. Although such methods potentially provide employers with candidate referrals for open positions, the platforms do not provide employers with any way to measure the quality of the referrals. For example, an employer may receive a candidate referral for an open position where the referral was made based solely on the academic background of the candidate. However, the candidate might not be interested in a new position or may work in an entirely unrelated industry. As such, most referral platforms typically leave employers with low value referrals that do not help them find the professional talent they are looking for. Accordingly, existing referral platforms lack the effectiveness and trustworthiness necessary for the modern professional workforce.

Embodiments provide an Internet-based professional talent management platform. More specifically, embodiments provide systems for providing access to professional talent, including, but not limited to, through recruitment and referral systems. For example, embodiments provide systems and methods for the consistent generation of quality referrals to employers. Embodiments described herein are configured to assist individuals, such as hiring managers, find quality employees and/or contractors as efficiently as possible.

In addition, embodiments are configured to implement an Internet-based approach that transforms the traditional, hierarchical staffing model into a model based on an online long-term incentive referral network. Certain embodiments are configured to use a unique business model and software to match demand for qualified employees with a supply of job seekers via the Internet. For example, Certain embodiments assist in identifying increased numbers of qualified talent in a more efficient way, transforming conventional talent management approaches.

Furthermore, embodiments provide incentives for members and associates of the professional talent management platform to actively participate in the recruitment and referral systems. As a non-limiting example, one embodiment provides that the incentives may consist of certain rewards allocated to platform members for directly or indirectly referring a candidate to an open position posted on the platform if the candidate ultimately is hired for the open position.

Embodiments are configured to generate a system of metrics for referrals made within the talent management platform. According to embodiments, each platform member has a credibility score that represents a measure of, inter alia, the quality of his referrals made within the platform. In addition, the credibility score may also be influenced by the individuals invited to join the platform by a member. As a non-limiting example, the quality of the referrals made may be measured according to certain referral characteristics, including, but not limited to, how the referred candidate fits the job requirements or whether the referred candidate actually is interested in the position. In addition, embodiments provide that each referral made by a member may influence the overall credibility score.

According to embodiments, employers may view the credibility score of the member making a referral to one of their job listings. As such, an employer will likely interact with candidates referred by members with a higher credibility score before those referred by a member with a lower credibility score. In addition, candidates are motivated to provide quality referrals because their ability to interact with the platform and collect rewards may be affected by their credibility score. As such, platform members will spend more time researching a referral, taking time to understand the position, to ensure the referral is a good fit for the position before making the referral.

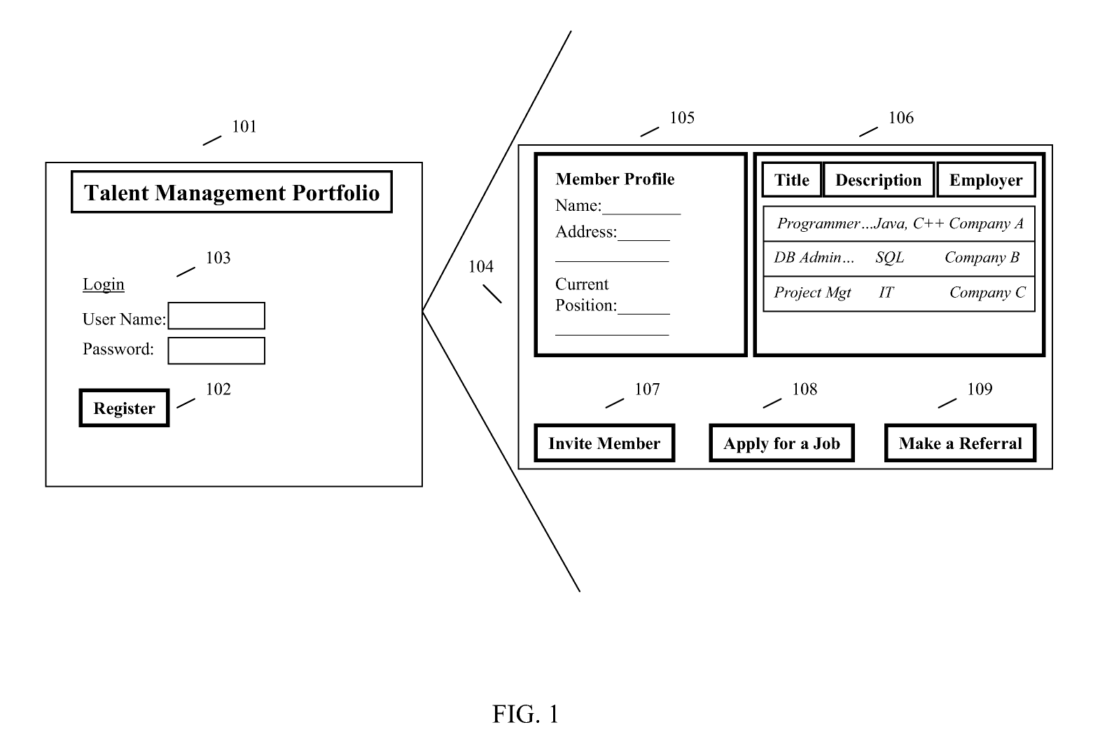

Referring to FIG. 1, therein is depicted an example talent management platform interface according to an embodiment. In the embodiment depicted in FIG. 1, the talent management platform is implemented as an Internet-based service with an interface 101 accessible through a web browser. According to embodiments, individuals register 102 as a new member at the platform web site. As an example member, consider an information technology professional, such as a software engineer, a network engineer, a project manager, a help desk professional, a database analyst, an ERP specialist, a web developer, a graphics designer, or a technical writer. In addition, embodiments provide that the member may take on different roles as part of his or her membership. Illustrative and non-restrictive examples of member roles include seeking full time employment, referring colleagues for open positions (jobs), and acting as a hiring manager or a consultant for one or more companies.

Registration may include choosing a member name and password, filling out a member profile (which can include for example both professional and personal information fields) and saving the membership information. In at least one embodiment, becoming a member and maintaining a membership will not require a fee. In another embodiment, a member may register using credentials from a social networking service, including, but not limited to, LinkedIn® or Facebook®. Facebook is a registered trademark of Facebook, Inc. LinkedIn is a registered trademark of LinkedIn Ltd.

After registering as a platform member, embodiments provide that a user may login 103 to the platform and access certain functions and services 104. For example, the functions and services may be available through a member profile or dashboard interface. As non-limiting examples, functions and services 104 may include creating and editing a member profile 105, viewing posted jobs 106, inviting members to join the platform 107, applying for a job 108, and referring a candidate for a job 109.

After a member has registered, certain embodiments provide that the talent management platform may utilize various methods to verify the member. According to embodiments, verification may be rigorous and may include one or more of the following: credit check(s), drug screening(s), verification of resume information (for example, education and employment information), and requiring direct invitation from an existing member.

Certain embodiments are configured to track a large amount of information regarding members. Such information may include, but is not limited to, social networking site information, including profile and connection information; information resulting from background checks, credit checks, and/or drug screenings; customer ratings; basic demographics; resume information; and member invitation, platform promotional, and job listing procurement information. Such information may be gathered and organized by certain embodiments to form a repository of information regarding a particular member or members. In addition, embodiments may be configured to require such information from members and that some or all of the information be made accessible, for example, in an effort to create an exclusive set of members, as reflected by the information gathered and made available regarding the members.

Embodiments provide for talent management platform function interfaces that may be accessed from within the talent management platform interface. For example, a community-based user interface modality may be available according to embodiments, which integrates social networking sites, communications modalities (e.g., email and instant messaging), a jobs posting service, as well as various other web 2.0 capabilities. A credibility score interface may include, but is not limited to, a member rating system, a system providing periodic to continuous feedback for members, and a validity checking system that may conduct and display results relating to various checks, such as credit and criminal background checks. In addition, embodiments provide for one or more interfaces that may include a reserving capability, a recruiting capability, or a retaining capability for members conducting recruiting services. Certain embodiments may further provide a growth interface according to an embodiment that includes, for example, an incentive plan and tracking thereof, a dashboard for hosting widgets, and accounting capabilities.

Embodiments provide for a talent management platform user interface wherein a member may access multiple aspects of the platform from a unified interface. As a non-limiting example, the member may access the interface and view a list of connections, which may comprise platform network connections or external network connections (e.g., social network connections), and associated information. For each connection, a list of jobs wherein the connection may be a quality referral may be listed along with information related to each listed job. As such, a user may view all of his connections and all available jobs where the connection may be a quality referral from a common interface. According to embodiments, the member may select to view all of the available jobs and the interface would display potential referrals derived from the member's connections. In addition, embodiments provide that the member may be able to use the interface to view all available jobs, for example, ranked by how well they fit the member's profile and qualifications.

Embodiments are configured to provide members with opportunities including but not limited to contract assignments, full time jobs, projects, and freelance opportunities. Certain embodiments are configured to reward members for certain services, such as referring another member successfully or building a network from which a qualifying referral is received. According to embodiments, rewards may take various forms, including, but not limited to, increased member ranking, financial or other forms of remuneration, charitable donations, advanced access to job postings, enhanced referral abilities, or some combination thereof. In addition, embodiments are configured to make automated attribution of rewards to members. For example, a member may link a payment account to, or establish an in-house account with, the platform system and receive regular (for example, monthly) distributions of rewards (for example, payments/account deposits) for his or her qualifying events. Furthermore, certain other embodiments provide that members may designate one or more charitable endeavors to receive earned rewards.

Each member may have a network according to embodiments. For example, embodiments provide that a user may invite members to join his or her network, while other embodiments may leverage social networking web sites to assist members in building a network, as by leveraging a member's existing contacts from other social networking sites as a starting point for identifying candidates for referral. According to embodiments, if a user registers using social networking credentials, the talent management platform may obtain available social network information, including the profile information of the user's social network contacts. As such, certain embodiments are configured to interface the talent management platform with various other social networking web sites and other web sites to facilitate information retrieval and importation from these other web sites, such as contacts lists, member characteristics, or organization characteristics. The member's network may, for example, comprise a referral network, such that a member may receive a reward when any one in his or her network receives a reward.

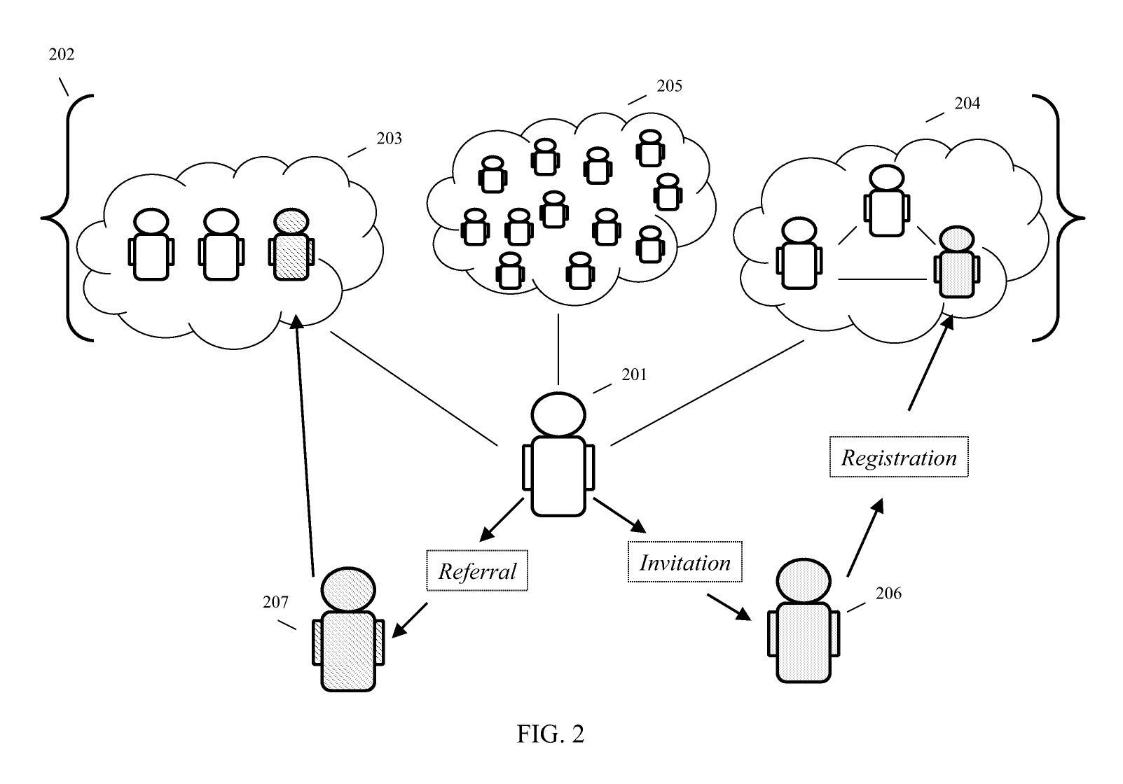

Referring to FIG. 2, therein is depicted an example member network for according to an embodiment. A talent management platform member, Member 1, 201 may have a network 202 consisting of connections, including, but not limited to, referral connections 203, member connections 204, and outside network connections 205.

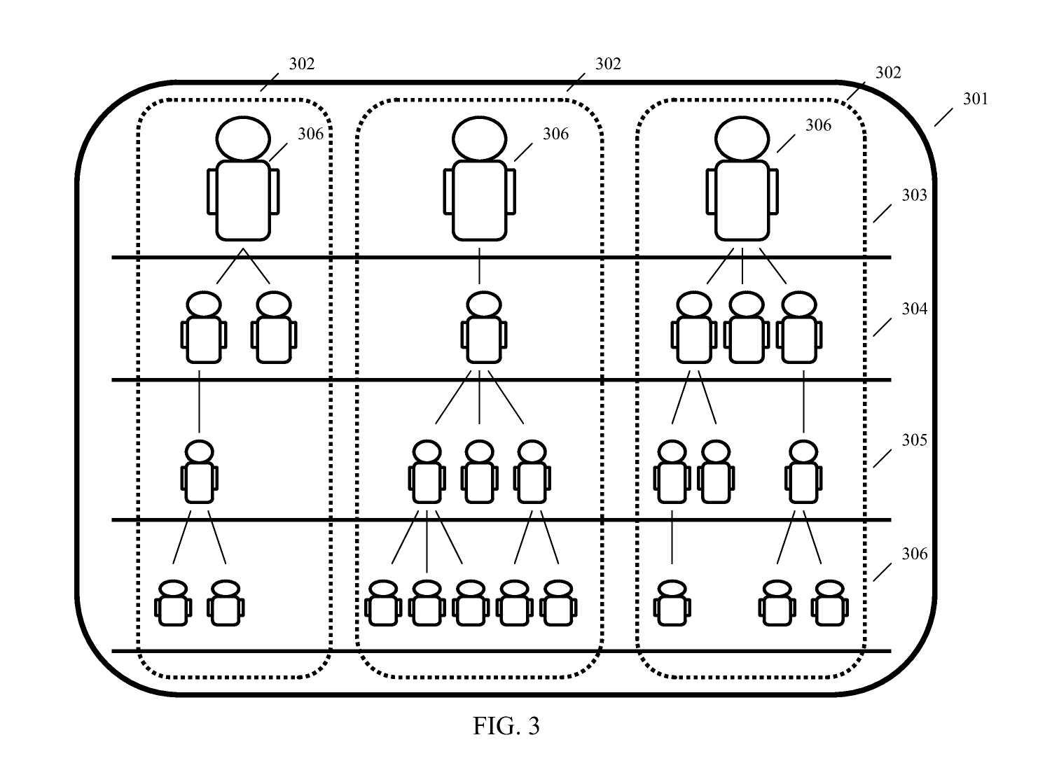

According to embodiments, member connections 204 may consist of platform members in Member 1's 201 network 202. For example, if Member 1 201 invites Member 2 206 to join the talent management platform and Member 2 206 registers with the platform, Member 2 206 is in Member 1's 201 network 202, more specifically, as a member connection 204. In addition, platform members who register responsive to invitations from members in Member 1's 201 network 202 become a part of Member 1's 201 network 202, for a certain number of levels. FIG. 3, discussed below, provides more detail regarding different member connection levels. Embodiments provide for the automated handling of invitations, for example, by a member executing an invitation function from the talent management platform interface and providing certain information regarding the invited individual, such as the individual's email address. The invitee subsequently may respond to the request and register as a member of the platform.

Embodiments provide that referral connections 203 may be comprised of platform referrals related to Member 1 201, such as referrals made directly by Member 1 or referrals made by members of Member 1's 201 network 202 (i.e., member connections 204) for a certain number of levels. In a non-limiting example provided in FIG. 2, Member 1 201 refers Candidate 1 207 for a position and, in response, Candidate 1 207 becomes linked to Member 1 201 as a referral made by Member 1 201 within the platform. Furthermore, embodiments provide that a member's network may consist of outside network connections 205, such as social networks the member has joined. For example, if Member 1 201 is a member of LinkedIn®, Member 1's 201 LinkedIn® accessible network of connections may be accessed as outside network connections 205 in Member 1's 201 network 202.

Embodiments are not limited to the types, number, and form of the networks 202-205 described in FIG. 2, as this figure depicts one non-restrictive embodiment and the networks provided therein are for illustrative purposes. According to embodiments, many different networks and sub-networks may be provided in multiple potential configurations. In addition, embodiments provide that there may be overlap between the different networks. As an illustrative and non-restrictive example, Member 1 201 may invite a member from his outside network connections 205, if the invitee accepts the invitation, then the invitee will become a member connection 204 of Member 1 201. Thus, the invitee will belong to Member 1's 201 outside network connections 205 and his member connections 204. Furthermore, if Member 1 201 then refers the invitee to a position within the platform, the invitee will additionally belong to Member 1's referral network 203.

Embodiments provide for a multi-level or multi-tiered network. In a non-limiting example, a member network may be comprised of four levels, with the member himself occupying the first level. According to embodiments, if a first member directly interacts with a second member, the second member may become a member of the first member's network at the second level (the first level below the member himself). Non-limiting examples of interaction include inviting a member to join the network or referring an individual for a position. In addition, when a member in the first member's second level directly interacts with a third member, the third member may become a member of the first member's third level (and a member of the second member's second level). Embodiments provide that the addition of connections within a member network may be added accordingly, including to more remote levels.

Referring to FIG. 3, therein is depicted an example multi-level member network according to an embodiment. The talent management platform network 301 consists of platform members each associated with a member network 302, wherein each member network may be comprised of multiple levels. In the illustrative and non-restrictive example shown in FIG. 3, the member network has four levels 303-306, although more or less levels are possible. According to embodiments, the first level 303 consists of platform members 307. The remaining levels 303-306 consist of the network connections of the members 307 and indicate the relatedness between platform members. For example, if a first member invites an invitee to join the network and the invitee registers with the network, the invitee becomes a member of the first member's network at the second level 303 (the first level below the actual member). In addition, embodiments provide for multiple types of networks (not shown), such as a public platform network and one or more private networks each associated with a private entity.

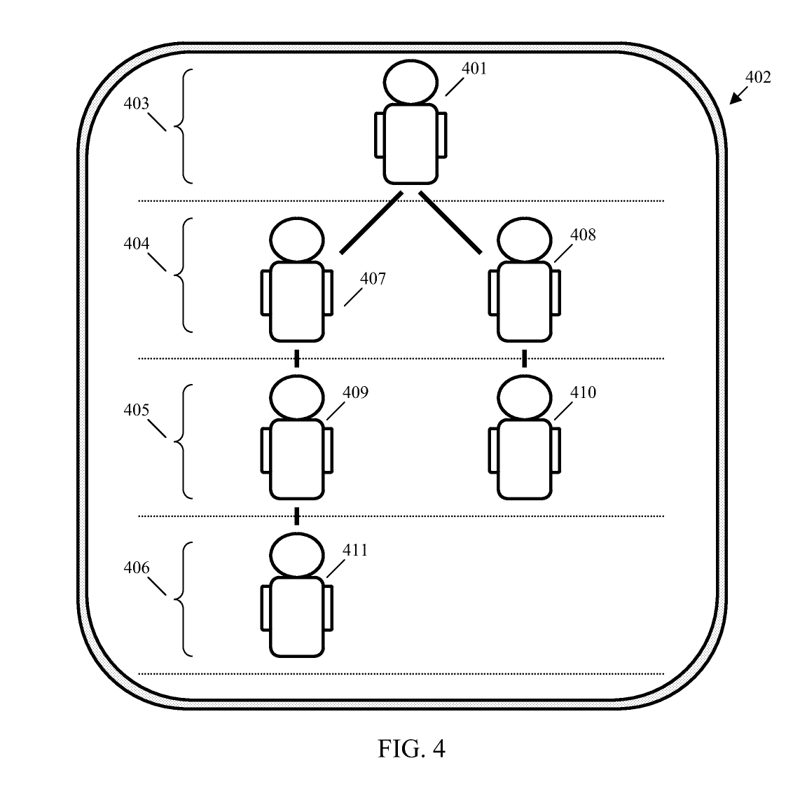

In FIG. 4, therein is provided an example member network according to one embodiment. Member 1 401 is associated with a network 402 comprised of four levels 403-406. The first level 403 consists only of Member 1 401, who may be considered the “parent” node of the network 402. The second level 404 consists of network members directly related to Member 1, such as through invitation or referral, and may be considered the “child” nodes of the network 402. A non-limiting example provides that if Member 1 401 invites Member 2 407 to join the talent management platform and Member 2 407 subsequently registers, then Member 2 407 becomes a member of Member 1's 401 network 402. Member 2 407 is in the second level 403 because Member 2 407 is directly related to Member 1 401 because Member 2 407 joined the platform responsive to an invitation from Member 1 401. In another non-limiting example, if Member 1 401 referred Member 3 408 to a position, Member 3 408 becomes connected within Member 1's 401 network 402 at the second level 403 because Member 3 408 is directly related to Member 1 401 through the referral.

The third 405 and fourth 406 levels are indirectly related to Member 1 401 through activity by members related to Member 1 401 at a higher level. A non-restrictive illustration provides that if Member 2 407 invites Member 4 409 to join the platform, when Member 4 409 registers, Member 4 409 becomes a connection in Member 1's 401 network 402 at the third level 405. Member 4 409 is indirectly related to Member 1 401 because Member 4 409 joined the network responsive to an invitation from a member related to Member 1 401 (i.e., Member 2 407). Another example provides that if Member 3 408 refers Member 5 410 for a position, Member 5 410 subsequently joins Member 1's 401 network 402 as a third level 405 member. Embodiments provide that the non-limiting example of network relationships may continue for one or more levels, such as level four 406 depicted in FIG. 3. For example, if Member 4 409 subsequently refers Member 6 411 for a position, Member 6 411 may be connected to Member 1 401 in level four 406 of the network 402.

In addition, embodiments provide that there may be overlap and/or shared connections between member networks. As a non-limiting example, Member 4 409 is a second level member of Member 2's 407 network (not shown) because Member 4 409 is directly related to Member 2 407 through Member 2's 407 invitation. In addition, Member 4 409 is also a member of Member 1's 401 network 402 at the third level 405. In addition, Member 5 410 is a second level connection in the network of Member 3 408 (not shown) and a third level 405 connection in the network 402 of Member 1 401.

Following registration and verification, embodiments provide that members may have access to job postings, which may include a frequently updated listing of job postings, such as daily updated job postings. A member, in response to reviewing the job postings, may search his or her personal network for individuals that may match the job postings. Embodiments may automate this search by automatically suggesting certain “friends” or other such individuals connected to the member that may qualify. Such automated suggesting may include, for example, comparing one or more metrics associated with the job posting to one or more metrics associated with the “friends” profiles in the member's personal network on the system (which again may be imported from other web sites). Thereafter, the member may make a referral.

Certain embodiments provide systems and methods for implementing a dual incentive model for professional talent management. A member has an incentive to recruit and provide references for quality candidates because a member's reward level may depend in part on the quality of the candidates produced, as tracked over time and reported on by other members, which can include clients. For example, a member's reward (such as level of compensation) may be correlated with the member's rankings. Moreover, members may have an incentive to recruit and provide quality candidates because quality and loyalty and retention of candidates may be tracked within the system and reported on the member's profile. Similarly, members providing other services (other than recruiting) may likewise have incentive to provide quality, reliable services because metrics can similarly be employed to track these member activities over time as well.

Certain embodiments allow for better, faster and cheaper location of talent compared to prior talent management approaches, for example by leveraging member's use of social networking web sites. This is in part because according to certain embodiments, more people will be looking for the desired talent, for example by employing contacts from other networks, including social networking sites. Members trying to identify qualified talent will be highly motivated to do so, both because positive incentives (for example, remuneration) and negative incentives (decreased member ranking or credibility score) may be accrued over time. Moreover, certain embodiments provide for more passive candidates to be identified, for example by leveraging interaction with other social networking web sites, with enforced credibility for members recommending these passive candidates. Certain embodiments will reduce costs associated with talent management by virtue of having less turnover. For example, as a result of more qualified candidates being identified and recommended in the first place due to a long term incentive approach according to embodiments.

A system according to embodiments may include one or more modules such as a candidate module, a jobs module, a credibility score module, a reference/referral module, a rewards module and a communications module. The system may communicate via the communications module with one or more remote devices such as a member's client device (for example, a personal computer or cell phone), one or more other web sites hosted by remote devices (for example, servers), such as social networking sites or other web sites (for example, customer sites or industry web sites).

According to embodiments, the candidate module may be configured to store one or more lists of potential candidates, for example, members within a particular member's network of contacts or other contacts as identified from other web sites. Embodiments provide that the jobs module may be configured to store one or more jobs listings, such as listings submitted by potential employers looking for qualified professional talent. Embodiments provide that the referral/reference module may be configured to store one or more lists of contacts actually referred or referenced by a member for particular positions. According to embodiments, the credibility score module may be configured to store one or more credibility scores associated with a member's performance within the system, for example, over specific period of time or over the duration of a user's membership. Embodiments provide for a rewards module that may be configured to store accounting details, such as one or more rewards awarded to a member for past services, account details, and the like. Each of the modules may be configured according to embodiments to execute computer program code configured to carry out specific acts or functions associated with storing, updating, or modifying, relevant information associated with the functionality of the module. Moreover, systems consistent with embodiments may contain more or less modules than illustrated, such as two modules being consolidated and/or additional modules being added for executing functionality consistent with the systems and methods described herein. Moreover, the modules may be linked or combined in a variety of ways depending upon the particular use contemplated.

Each of the modules may be configured according to embodiments to execute computer program code configured to carry out specific acts or functions associated with storing, updating, or modifying, relevant information associated with the functionality of the module. Moreover, systems consistent with embodiments may contain more or less modules than illustrated, such as two modules being consolidated and/or additional modules being added for executing functionality consistent with the systems and methods described herein. Moreover, the modules may be linked or combined in a variety of ways depending upon the particular use contemplated.

Embodiments may provide a member home page for display on a member's device, such as a personal computer, cell phone, or other mobile computing device. The member home page may contain a variety of functional units for executing commands requesting that a system as described herein perform functions consistent with those described herein. For example, a member homepage may include, but is not limited to, providing an email client, a messaging client, an accounting client, and an invite/recruiting client. The invite/recruiting client may provide functionality supporting member recruiting activities, such as providing an option to invite a new member to join the system, invite an existing member to become part of the particular member's personal network, and conducting recruiting services such as selecting another member and referring them as a candidate for a job opening. The accounting client may provide accounting services to the member, such as linking a member account to that of a financial institution such that the rewards issued to a member can be direct deposited into the member's account at the given financial institution.

In addition, the member home page may include a variety of tabs that, in response to selection, provide a convenient display of member activities. A contacts tab may be provided that displays a list of contacts of the member upon selection. The contacts may include both member network contacts within the system as well as member contacts as derived from one or more external networking sites, such as social networking sites, to which the member belongs. A jobs listing tab, may include, for example, a listing of jobs deposited within the system by clients looking to fill open positions. A rewards tab may include a listing of current, past or pending rewards a member has or can obtain via activities within the system. A credibility score tab may include the member's credibility score regarding referral activities within the system. A referrals tab may include a listing of referrals the member has made. A references tab may include a list of references the member has made.

Furthermore, the member's home page may include links to other web sites, such as other social networking web sites the member belongs to or web sites dedicated to certain professional organizations. The member's home page may also include a search function such that the member may search within the system for other pages, such as pages of other members, or for posted jobs. The member's homepage according to certain embodiments may display one or more member rankings or credibility scores, viewable by other members.

Embodiments described herein provide for one or more incentive models for providing rewards to members for qualifying referrals. In addition, embodiments provide incentives configured to provide members with long-term motivation to actively participate in the talent management platform, including the continuous placement of quality referrals. For example, one embodiment provides that a member may receive a reward whenever a member of their network receives a reward.

According to embodiments the incentive rewards may be based on levels. As a non-limiting example, a member may receive a first level reward for a qualifying direct referral; a member may receive a second level reward for a qualifying indirect referral; and a member may receive a third level reward for a qualifying remotely connected referral from his or her network. According to certain embodiments, a first level reward may be of higher value than a second level reward, a second level reward may be higher than a third level reward, and so on. Referring to FIG. 4, a first level reward may involve members in the second level 404 of Member 1's 401 network 402; second level rewards may involve members in the third level 405 of the network 402; and third level rewards may involve members in the fourth level 406 of the network 402.

Embodiments may utilize one or more categories of the member information to implement a metric-based scoring (“ranking”) of the members. Metrics may include, but are not limited to, customer satisfaction with the member; number of members registered as a result of invitations sent by the member; utilization of the member's services; a member metric combining one or more member information categories, such as a member “batting average” (customer satisfaction combined with utilization), and/or a member “runs batted in” (customer satisfaction combined with number of recruits as compared with customer satisfaction combined with utilization); and the quality of the members referrals. Certain embodiments are configured to utilize a metrics based scoring system in order to ensure an aggressive quality assurance program regarding the members. In this way, those considering using one or more of the member's services can gain assurance that a member and referrals made by the member are of the utmost quality based on past performance.

As discussed herein, certain embodiments are configured to make the referral decision matter more than is usual to the member. In addition to receiving a reward, the member should be cognizant the potential negative implications of making an inappropriate referral. Such negative implications may include, but are not limited to, a reduction in the member's rating, ranking, and/or credibility score within the system, which is visible to others.

Typical factors affecting the hiring decision are education, experience, and one or more references. Certain embodiments are configured to enable those making hiring decisions to have more confidence in the reference(s) submitted. Those making hiring decisions should take into account why they need a reference, how often they receive a negative one, and how they can verify the reference, and whether a member making a reference is accountable for the quality of the reference in some way. Accordingly, certain embodiments are configured to make references matter to those involved, such as those acting as a reference or making a referral. By way of example, certain embodiments are configured to measure the quality of a particular reference's past performance in that capacity and make that past performance accessible to certain individuals. Moreover, certain embodiments may correlate reward level to member ranking in this regard, thus tying compensation level to credibility within the system. Thus, certain embodiments are configured to score members over time such that an accountability is attached to the each reference, and that accountability (for example, ranking) follows the member over time.

Certain embodiments are configured to rank a reference utilizing detailed reference rankings as one or more member rankings, and associate them with members choosing to act as references. Embodiments provide that reference rankings may take into account certain reference characteristics, including, but not limited to, how accurate the reference's description was, how satisfied the recipient of the reference was, or how responsive the reference was to submitted communications. According to an embodiment, a user interface may be provided wherein the recipient of the reference can review the performance of the reference at a later time.

Thus, certain embodiments are configured to provide quality assurance in the form of a credibility index or score for references, such as reflected by a member's customer satisfaction score. Such visibility and accountability within the system will make decisions by hiring managers easier inasmuch as they will have some subjective or qualitative way of determining how reliable a particular reference is likely to be. Moreover, long term incentives can attach to members acting as references. For example, certain embodiments are configured to remove certain privileges, such as recruiter privileges, from a member if his or her credibility index drops below a certain predetermined threshold value. In another example, embodiments may provide enhanced job listings, such as the ability to view job listings before other members, to members with a score above a certain threshold.

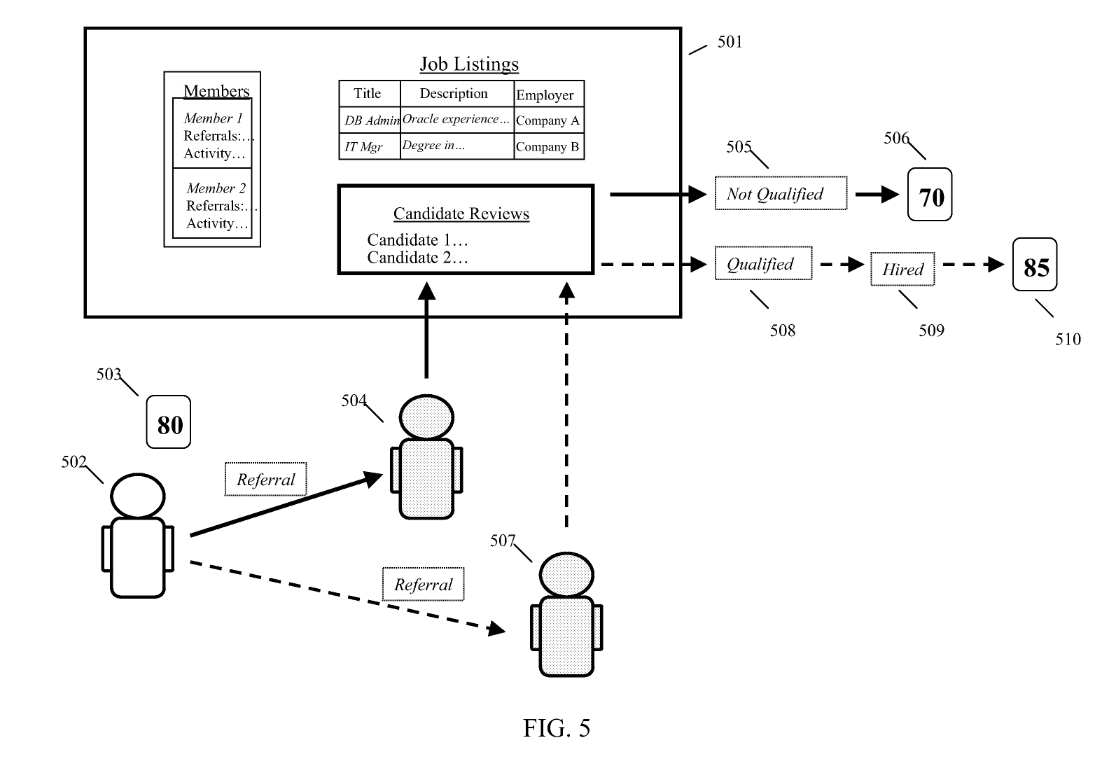

Referring to FIG. 5, therein is depicted an example of calculating a credibility score according to an embodiment. The talent management platform 501 is configured according to embodiments to assign a credibility score to each member. In the example depicted in FIG. 5, the credibility score is within a range of 0-100. Member 1 502 has a credibility score 503 of 80. Member 1 502 refers Candidate 1 504 for a job listing. Candidate 1 504 is reviewed by the talent management platform 501 before being sent to the listing employer. The talent management platform 501 determines that Candidate 1 504 is not a good fit for the job listing 505, for example, because Candidate 1 504 does not have the requisite academic background and work experience. As such, the talent management platform 501 will not forward the referral to the listing employer. In referring Candidate 1 504, Member 1 502 has made a low quality referral which will impact his credibility score. For example, Member 1's credibility score may be decreased from 80 to 70 506.

In the example illustrated in FIG. 5, Member 1 502 also refers Candidate 2 507 to another job listing. The talent management platform 501 determines that Candidate 2 507 is a good fit for the job listing 508. Accordingly, the platform forwards the Candidate 2 507 referral to the listing employer, who interviews and ultimately hires Candidate 2 507 for the position. As such, Member 1 502 has made a quality referral because Candidate 2 507 was a good fit for the job listing and was hired by the Employer. As a result of the quality referral, Member 1's credibility score increases from 70 to 85 510.

Embodiments are configured to determine one or more member credibility scores using multiple arrangements of referral credibility factors. According to embodiments, referral credibility factors may include, but are not limited to, how well the candidate matches the job requirements; whether the candidate is receptive to taking a new position; how many steps along the job hiring process the candidate advances; if hired, how long the candidate remains in the position; and how well does the candidate perform for the employer; and combinations thereof.

Embodiments provide that how well the candidate matches the job requirements and whether the candidate is receptive to taking a new position may be determined based on a review by the talent management platform, by the recipient of the referral, or some combination thereof. According to embodiments, how many steps the candidate advances along the job hiring process may be based on tracking candidate progress through a series of steps typical in the hiring process. For example, steps may include being selected in the final group of applicants, being selected for a first interview, being selected for a second interview, and being made an offer by the employer.

In addition, embodiments provide for employer feedback and/or outreach by the talent management platform to the employer to determine information pertaining to the referred candidate, including, but not limited to, how well the candidate fit the job listing description, how receptive the candidate was to taking a new position, how long the candidate remains in the position or how well the candidate performs for the employer. For example, embodiments may provide an application or platform interface where referral recipients, such as employer members of the platform, may enter information regarding candidates referred and employees hired through the platform.

A member's credibility score is associated with their profile and may be calculated using different methods according to embodiments. For example, each referral made by a member may be individually scored using the same scale as the credibility score, such that the score associated with each referral may be averaged into the member's overall credibility score. For example, if a member has made three referrals with scores based on a 0-100 scale of 80, 75, 70, his current credibility score is the average of the individual scores, as follows: (80+75+70)=75. If the same member makes another referral which achieves a credibility score of 85, then the member's credibility score will be the average of the average of the new set of referral credibility scores, as follows: (80+75+70+85)=77.5.

According to another embodiment, each referral subtracts or adds to a member's overall credibility score according to various score configurations. For example, a member may lose a certain number or percentage of points from their score for a candidate that is not a good fit for the position, but may lose a lesser number or percentage of points if the candidate is interviewed, but is ultimately not hired. Similarly, a member's credibility score may be increased if the referred candidate is hired for the position, and their credibility score increased further if the candidate stays in the position for more than one year. A non-limiting example provides that, using a 0-100 scale credibility score, a user may lose 20 points from their credibility score for referring an unqualified candidate, but may only lose 5 points for a qualified candidate who is not hired for the position. In a related example, a user may have 5 points added to their credibility score for referring a candidate that is interviewed for the position and 10 points for referring a candidate that is hired for the position. These examples are meant only as illustrations and are non-exhaustive, as embodiments may calculate credibility scores according to any applicable process.

According to embodiments, a credibility score may be determined based on the progress of a referred candidate through a defined hiring process. For example, the talent management platform may provide a job applicant progress path comprising one or more of fitness, candidate interest, first interview, second interview, job offer, job acceptance, employment duration, and employment performance steps, or some combination thereof, including other, non-listed steps. Embodiments provide that the credibility score may increase as a referred candidate progresses through the job applicant progress path, and certain steps may also be weighted more than other steps.

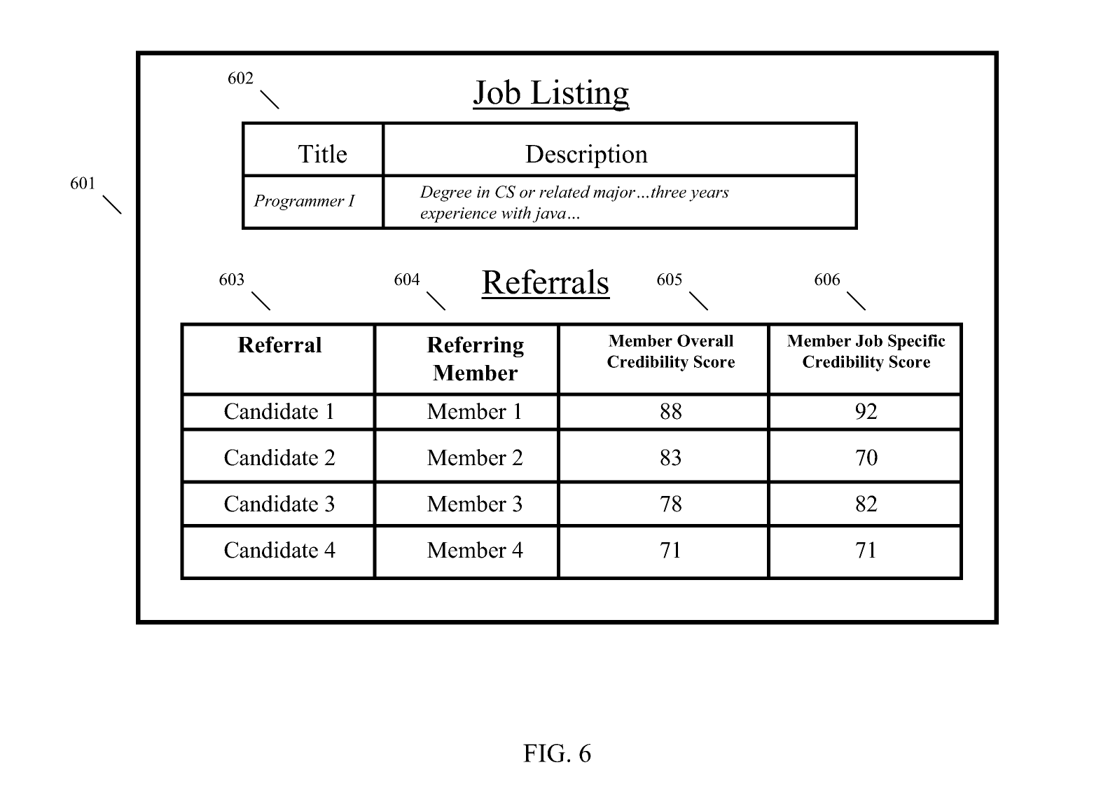

Referring to FIG. 6, therein is depicted an example of an employer member interface according to an embodiment. An employer member accesses one of its job listings 602 through a talent management platform employer interface 601. The interface 601 lists the referrals 603 received regarding the particular job listing 602. The referrals 603 are preferably indexed by one or more credibility scores 605, 606 of the members making the referrals 4604, and may include other information, such as the name of the candidate 603 and the name of the referring member 604.

In the non-limiting example depicted in FIG. 6, two credibility scores 605, 606 are shown. According to embodiments, a platform member may have a member overall credibility score 605 which is a member's credibility score within the platform without reference to a particular job listing. Embodiments may also provide for a member job specific credibility score 606, which takes the particular job characteristics (e.g., field, degree requirements, whether the job is a management level job, etc.) of the listing into account. Embodiments provide that the job specific credibility score 606 takes the overall credibility score and modifies it for the specific job posting to indicate the quality of a referral from a particular member for a particular job. As such, an employer viewing referrals 603 for a job listing 602 may see a member's overall credibility score 605 as well as a job specific credibility score 606 tailored for the employer's specific job listing 602.

As an illustrative and non-limiting example, a first member may have an overall credibility score, which is a measure indicative of the quality of the member's referrals within the platform, of 85 on a scale of 100. However, the first member may have worked with the referral for five years, giving him a better standpoint for making a referral than, for example, a person that the member may not have interacted with in a professional, working environment for this particular job listing. As such, embodiments may use known candidate, referring member, or position information to generate certain assumptions, inferences, and related information that may be relevant to the referral, the referring member, the position, or some combination thereof. In another example, the first member may have many years of experience in the particular field or technology listed in the job description. As such, the first member's referral is likely to be credible for the particular job listing. As a result, embodiments may provide a job specific credibility score for this particular job listing that is greater than the first member's credibility score. For example, the job specific credibility score may be 90, 5 points higher than the first member's overall credibility score of 85.

On the other hand, a member's referral may be less credible for a particular job listing. As a non-limiting example, a second member may have an overall credibility score of 85 and has made a referral for a job with a doctorate degree level requirement in a particular field. As such, embodiments may provide a job specific credibility score that is less than the second member's overall credibility score. For example, the job specific credibility score may be 75, 10 points less than the overall credibility score. The referrals 603 may be ranked by either credibility score 605, 606, for example, based on user preference.

Embodiments provide that the referral information, such as the name of the candidate 603 may be hyperlinked so that an employer may easily access the profile of a referred candidate through the employer interface 601 or other interfaces (not shown), such as a member or candidate interface. As shown in FIG. 6, an employer may have access to a quality measure of the referrals 603 through the credibility scores 605, 606. As such, the employer is more likely to accept a referral 603 from a member with a higher credibility score 605, 606.

Embodiments provide that a member's overall and/or position specific credibility score may be affected by other factors other than, or in addition to, past referral success rates. Illustrative and non-restrictive examples of such personal factors include academic degree, whether the referring member has management or hiring experience, evidence of job performance, whether the referring member has actually worked with the referred candidate, whether the member has relevant industry experience, how long the referring member remains in each employment position, or whether the referring member demonstrates a path of professional advancement throughout their career.

For example, embodiments may determine the credibility score by including one or more personal factors involving a referring member's highest academic degree or highest academic degree in relation to the level required for the referred position. For example, if a member only has a bachelor's degree, but is recommending a candidate for a position requiring a doctorate degree, this may negatively affect the member's credibility score as their referral for this position may not be as credible as a member with a similar academic degree. In another example, a referring member with management or hiring experience may have an increased credibility score over a member without such experience because it is more likely that such experience will result in higher quality referrals. According to embodiments, a member's credibility score may be determined based on past referrals, personal factors, or some combination thereof.

According to embodiments, a member's credibility score may be influenced by the member's interactions with the talent management platform or with other members. For example, a member's credibility score may be influenced by the quality or number of members invited to join the platform. As a non-limiting example, a member's credibility score may be lowered if he has invited another member whose credibility score is below a certain threshold or who makes one or more low quality referrals. In another non-limiting example, a member may have their credibility score decreased for not following certain platform rules or procedures, or for not providing full disclosure of information when required.

Embodiments provide that members may benefit from high credibility scores because their references will be listed higher as the candidates they refer will be more likely to fit the position, and therefore, selected by employers. In addition, embodiments provide that members with higher credibility scores may benefit in various other ways, including, but not limited to, increased incentive rewards in a system where a member's reward amount is influenced by their credibility score, enhanced access to job listings, platform functions or the ability to make more referrals per job. For example, a system where a member's reward amount is influenced by their credibility score may involve increasing a member's reward amount by a certain percentage if their credibility score is above a certain threshold, or decreasing a member's reward amount if their credibility score is below a certain threshold.

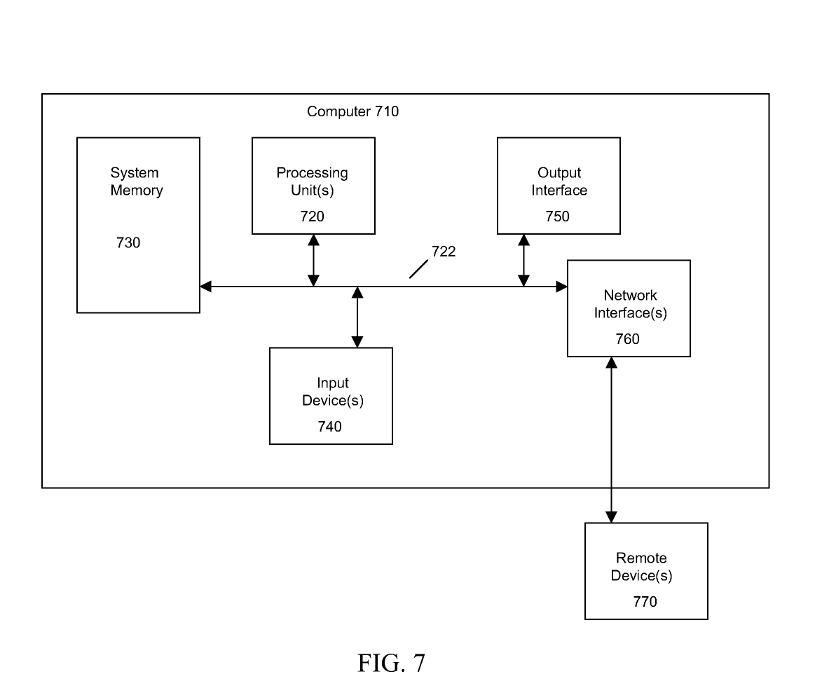

Referring to FIG. 7, it will be readily understood that certain embodiments can be implemented using any of a wide variety of devices or combinations of devices. An example device that may be used in implementing one or more embodiments includes a computing device in the form of a computer 710. In this regard, the computer 710 may execute program instructions configured to associate one or more credibility scores with one or more members of a professional talent management platform.

Components of computer 710 may include, but are not limited to, a processing unit 720, a system memory 730, and a system bus 722 that couples various system components including the system memory 730 to the processing unit 720. The computer 710 may include or have access to a variety of computer readable media. The system memory 730 may include computer readable storage media in the form of volatile and/or nonvolatile memory such as read only memory (ROM) and/or random access memory (RAM). By way of example, and not limitation, system memory 730 may also include an operating system, application programs, other program modules, and program data.

A user can interface with (for example, enter commands and information) the computer 710 through input devices 740. A monitor or other type of device can also be connected to the system bus 722 via an interface, such as an output interface 750. In addition to a monitor, computers may also include other peripheral output devices. The computer 710 may operate in a networked or distributed environment using logical connections to one or more other remote computers or databases. The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
one or more processors;
a system memory operatively coupled to the one or more processors; and
one or more professional talent management modules communicatively coupled to the system memory, wherein the one or more professional talent management modules are adapted to:
register one or more members;
list one or more positions;
accept one or more referrals for the one or more position from the one or more members; and
associate one or more credibility scores with the one or more members.

2. The system according to claim 1, wherein the one or more credibility scores are configured to indicate a reliability of referrals from the one or more members.

3. The system according to claim 2, wherein the one or more credibility scores are determined based on previous referrals of the one or more members.

4. The system according to claim 3, wherein a credibility score of a member is increased if a referral is hired for a referred position.

5. The system according to claim 4, wherein the credibility score of a member is decreased if the referral is not hired for the referred position.

6. The system according to claim 4, wherein the credibility score of the member providing the referral hired for a referred position is affected by one or more employment characteristics, the one or more employment characteristics comprising employment duration and employment proficiency characteristics.

7. The system according to claim 1, wherein the one or more credibility scores are based on one or more characteristics of the one or more members.

8. The system according to claim 7, wherein the one or more characteristics comprise an academic degree level, an employment history, an industry experience, and a referral work relationship.

9. The system according to claim 1, wherein access to the one or more credibility scores of the one or more members making one or more referrals for a listed position is provided to one or more employers associated with the listed position.

10. The system according to claim 1, wherein the one or more professional talent management modules are further adapted to:
configure the one or more credibility scores to indicate a reliability of referrals from the one or more members, the reliability based on previous referrals of the one or more members;
obtain one or more characteristics of the one or more members, the one or more characteristics comprising an academic degree level, an employment history, an industry experience, and a referral work relationship; and
associate position specific credibility scores with the one or more members making referrals for the one or more positions, the position specific credibility scores determined by adjusting the one or more credibility scores by applying the one or more characteristics of the one or more members making referrals to requirements of the one or more positions;
wherein referrals for the one or more positions are provided to one or more employers associated with the one or more positions, the referrals being ranked by the one or more credibility scores or the position specific credibility scores.

11. A method comprising:
registering one or more members;
listing one or more positions;
accepting one or more referrals for the one or more position from the one or more members; and
associating one or more credibility scores with the one or more members.

12. The method according to claim 11, wherein the one or more credibility scores are configured to indicate a reliability of referrals from the one or more members.

13. The method according to claim 12, wherein the one or more credibility scores are determined based on previous referrals of the one or more members.

14. The method according to claim 13, further comprising:
wherein a credibility score of a member is increased if a referral is hired for a referred position;
wherein the credibility score of a member is decreased if the referral is not hired for the referred position.

15. The method according to claim 14, wherein the credibility score of the member providing the referral hired for a referred position is affected by one or more employment characteristics, the one or more employment characteristics comprising employment duration and employment proficiency characteristics.

16. The method according to claim 11, wherein the one or more credibility scores are based on one or more characteristics of the one or more members.

17. The method according to claim 16, wherein the one or more characteristics comprise an academic degree level, an employment history, an industry experience, and a referral work relationship.

18. The method according to claim 11, wherein access to the one or more credibility scores of the one or more members making one or more referrals for a listed position is provided to one or more employers associated with the listed position.

19. The method according to claim 18, wherein the one or more referrals for the listed position are ranked based on the one or more credibility scores.

20. A computer program product comprising:
a computer readable storage medium having computer readable program code embodied therewith, the computer readable program code comprising:
computer readable program code configured to register one or more members;
computer readable program code configured to list one or more positions;
computer readable program code configured to accept one or more referrals for the one or more position from the one or more members; and
computer readable program code configured to associate one or more credibility scores with the one or more members.
